(19) United States
(12) Patent Application Publication
(10) Pub. No.: US 2020/0290178 A1
(43) Pub. Date: Sep. 17, 2020

(54) SOCKET STRUCTURE FOR INSTALLING AND REMOVING TIRES

(71) Applicant: Tsai-Fa Liu, Taichung (TW)

(72) Inventor: Tsai-Fa Liu, Taichung (TW)

(21) Appl. No.: 16/354,181

(22) Filed: Mar. 15, 2019

(51) Int. Cl. B25B 13/06; B60C 25/01

(52) U.S. Cl. CPC B25B 13/06; B60C 25/01

(57) ABSTRACT

A socket structure for installing and removing tires includes a sheathing action section, a neck buffer section and a power plug section, and the sheathing action section has an axial polygonal action hole, and the power plug section has an axial square hole and a radial through hole provided for plugging and connecting a power output shaft of a power tool to achieve the expected effect of outputting power. The sheathing action section has an edge thickening and reinforcing portion at the front end to improve the overall structural strength of the sheathing action section and achieve the effects of preventing damage and extending service life.

### BACKGROUND OF THE INVENTION

### 1. Fields of the Invention

The present invention relates to a socket structure, more particularly to a socket structure for installing and removing tires, and the socket structure has a better structural strength and is capable of extending the service life effectively.

### 2. Description of the Related Art

As the name suggests, a socket dedicated for installing and removing tires is a special tool used for installing and removing tires and the socket may be operated together with a relative power tool such as a pneumatic or electric tool for an expected installation or removal of a screw which is secured to a tire. In short, the socket usually requires a strong structural strength to withstand a high-strength torsional stress for a long period of time.

With reference to FIG. 5 for a conventional socket 40, the socket is integrally made of metal and substantially in a circular cylindrical shape, and the socket may be divided into a sheathing action section 41 and a power plug section 42, and the sheathing action section 41 has an axial polygonal action hole 43 for sheathing on a screw which is secured to a tire, and the power plug section 42 has an axial square hole (not shown in the figure) for connecting a power output shaft of a power tool, wherein the power plug section 42 has a radial through hole 44 provided for combining and positioning the power output shaft.

Although such conventional socket has been used for years, most users found that the outermost edge of the sheathing action section 41 may be easily damaged by inadvertent fall or accidental collision. In addition, the sheathing action section 41 has an insufficient strength/load capacity, and thus may be cracked or damaged easily. These products give users bad experience with a short service life. Obviously, such products require further improvements.

### SUMMARY OF THE INVENTION

An object of the invention is to apply an integral thickening technique to the peripheral surface of a sheathing action section of a socket to improve the structural strength without increasing the manufacturing cost or complicating the manufacturing procedure. The invention not just effectively extends the service life only, but also achieves the effects of preventing a severe crack of the sheathing action section and ensuring the safety of the users.

According to the invention, a socket structure for installing and removing tires includes a socket having a sheathing action section, a neck buffer section and a power plug section. The sheathing action section includes an axial polygonal action hole, and the power plug section has an axial square hole and a radial through hole. The sheathing action section has an edge thickening and reinforcing portion disposed at a front end thereof, and a primary thickening and reinforcing portion disposed at a rear end thereof.

### BRIEF DESCRIPTION OF THE DRAWINGS

The accomplishment of this and other objects of the invention will become apparent from the following description and its accompanying drawings of which:

FIG. 1 is a perspective view of the present invention;

FIG. 2 is an exploded view of the present invention combined with an outer ring plastic cover;

FIG. 3 is a planar schematic view of the present invention;

FIG. 4 is a planar schematic view of the present invention after being sheathed by an outer ring plastic cover; and

FIG. 5 is a perspective view of a conventional socket structure.

### DETAILED DESCRIPTION OF THE PREFERRED EMBODIMENT

To make it easier for our examiner to understand the objective of the invention, its features, and advantages, we use a preferred embodiment together with the attached drawings for the detailed description of the invention.

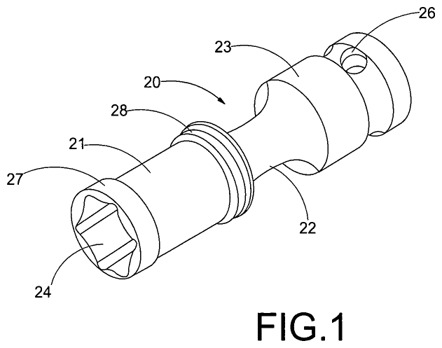

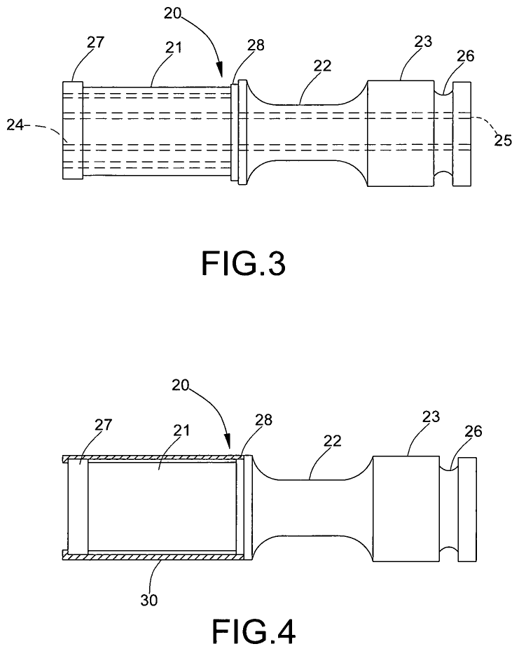

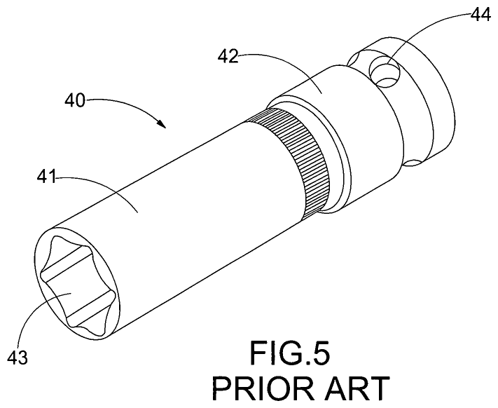

With to FIGS. 1 to 3 for a socket structure for installing and removing tires in accordance with the present invention, the structure comprises a socket 20 including a sheathing action section 21, a neck buffer section 22 and a power plug section 23, and the sheathing action section 21 has an axial polygonal action hole 24 sheathed on a screw which is secured to a tire, and the power plug section 23 has an axial square hole 25 and a radial through hole 26 provided for plugging a power output shaft of a power tool to achieve an expected power transmission effect, characterized in that the sheathing action section 21 has an edge thickening and reinforcing portion 27 disposed at a front end and a primary thickening and reinforcing portion 28 disposed at a rear end of the sheathing action section 21 to improve the overall structural strength of the sheathing action section 21 effectively, so as to prevent damage and extend service life.

Wherein, the edge thickening and reinforcing portion 27 is capable of withstanding unexpected collision or hitting and preventing its deformation or damage, and the primary thickening and reinforcing portion 28 is disposed adjacent to the neck buffer section 22, so that after the sheathing action section 21 is cracked by an external stress exceeding to its load capacity, the primary thickening and reinforcing portion 28 can control the cracking range of the material, so that the sheathing action section 21 will not be cracked completely, so as to prevent the cracked pieces from shooting at the users, and ensure the safety of use.

In addition, the neck buffer section 22 has an effect of providing instantaneous response to torsional stresses and high strength and toughness to the material of the socket when a force is exerted to the socket 20, so as to buffer the external force effective and reduce the risk of cracking the material. However, the design of such buffering technique is a well-known art used in various different hand tools and related assemblies, and thus will not be described in details.

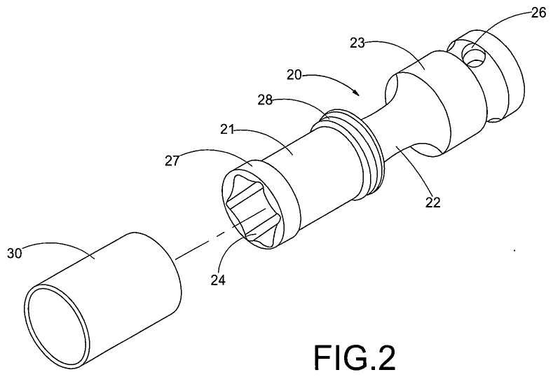

With referenced to FIGS. 2 and 4 for the actual application of the socket 20 in accordance with the present invention, an outer ring plastic cover 30 in a corresponding cylindrical shape is covered onto the outer periphery of the sheathing action section 21 to prevent damages of tire rims caused by collisions.

What is claimed is:

1. A socket structure for installing and removing tires, comprising:
a socket, including a sheathing action section, a neck buffer section and a power plug section, and the sheathing action section having an axial polygonal action hole, and the power plug section having an axial square hole and a radial through hole, characterized in that the sheathing action section has an edge thickening and reinforcing portion disposed at a front end thereof, and a primary thickening and reinforcing portion disposed at a rear end thereof, and the primary thickening and reinforcing portion being disposed adjacent to the neck buffer section.

2. The socket structure for installing and removing tires according to claim 1, wherein the sheathing action section has an outer periphery covered by a cylindrical outer ring plastic cover.
